(19) United States
(12) Patent Application Publication
(10) Pub. No.: US 2005/0208954 A1
(43) Pub. Date: Sep. 22, 2005

(54) User-tagging of cellular telephone locations

(75) Inventors: Jerome Boss, Bellevue, WA (US); Lili Cheng, Bellevue, WA (US); Cezary Marcjan, Redmond, WA (US); David Milstein, Redmond, WA (US); Gilad Odinak, Bellevue, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/070,473

(22) Filed: Mar. 1, 2005

Related U.S. Application Data
(63) Continuation of application No. 09/787,434, filed on Mar. 26, 2001, now Pat. No. 6,592,812.

(51) Int. Cl. H04Q 7/20

(52) U.S. Cl. 455/456.1; 455/558; 455/456.3

(57) ABSTRACT

A user-controlled cellular telephone positioning feature allows a cellular telephone user to correlate a user-specified location name with a cellular telephone location among one or more cells of a cellular telephone network. In one implementation, a cellular telephone location tagging application is stored and operated on a cellular telephone. The application obtains a cell identification string corresponding to a cell of a cellular telephone system with which cell the cellular telephone is in communication and allows the user to associate a location name and the cell identification string as location information for a selected location. Location data are maintained on a user's cellular telephone, and the user can selectively make the location information available others.

### CROSS-REFERENCE TO RELATED APPLICATION

This application claims priority to and is a continuation of U.S. patent application Ser. No. 09/787,434, filed Feb. 20, 2001, which is incorporated herein by reference.

### SUMMARY

The present invention relates to digital cellular telephones, and in particular to a cellular telephone location application and service that are controlled by a cellular telephone user.

The mobility of cellular telephones has provided a versatile, affordable, and convenient communication tool for large numbers of people. A mobile or wireless cellular telephone can be moved among communication cells of a cellular telephone network and maintain seamless communication with the network. Initially, cellular telephones were used solely for voice communications. As cellular telephones have improved and incorporated digital processing capabilities, such as in GSM-style digital cellular telephones, other communication capabilities have been added, such as text messaging of the type referred to as short message service (SMS) messaging that is commonly used in GSM cellular telephones.

An aspect of the present invention is the addition of a user-controlled cellular telephone positioning feature by which a cellular telephone user may correlate a user-specified location name with a cellular telephone location among one or more cells of a cellular telephone network. Such a user-controlled cellular telephone positioning feature maintains user privacy by maintaining location data on a user's cellular telephone. In contrast, cellular telephone network operators conventionally have been able to identify a cell within which a cellular telephone is located without a user's knowledge or permission. Such information has sometimes been used in law enforcement situations, but as a generally available resource would be viewed by many users as an undesirable invasion of privacy.

With location data maintained on a user's cellular telephone, the user can selectively make the location information available others. In one implementation, a cellular telephone location tagging application is stored and operated on a cellular telephone. The application obtains a cell identification string corresponding to a cell of a cellular telephone system with which cell the cellular telephone is in communication. The user associates a location name and the cell identification string as location information for a selected location. The user may also specify that the location information may be transmitted from the cellular telephone to a cellular telephone location service center that receives the location information and selectively forwards it to a predefined recipient (e.g., a telephonic or computer network service or user).

Additional objects and advantages of the present invention will be apparent from the detailed description of the preferred embodiment thereof, which proceeds with reference to the accompanying drawings.

### DESCRIPTION OF THE DRAWINGS

The present description will be better understood from the following detailed description read in light of the accompanying drawings, wherein:

FIG. 1 illustrates a GSM cellular telephone as an exemplary cellular telephone operating environment for an embodiment of the present invention.

FIG. 2 is a schematic diagram of a conventional cellular telephone system having multiple communication cells

FIG. 3 is a block diagram illustrating operation of a user-controlled cellular telephone location tagging application as stored in a cellular telephone memory.

FIG. 4 is a flow diagram of a first implementation of a user-controlled cellular telephone location tagging method.

FIG. 5 is a flow diagram of a second implementation of a user-controlled cellular telephone location tagging method.

FIG. 6 is a block diagram illustrating operation of a user-controlled cellular telephone location posting system for posting or otherwise providing location information regarding a cellular telephone.

FIG. 7 is a flow diagram of a cellular telephone location information method by which a cellular telephone system operator can provide a location information service to a cellular telephone user.

Like reference numerals are used to designate like parts in the accompanying drawings.

### DETAILED DESCRIPTION

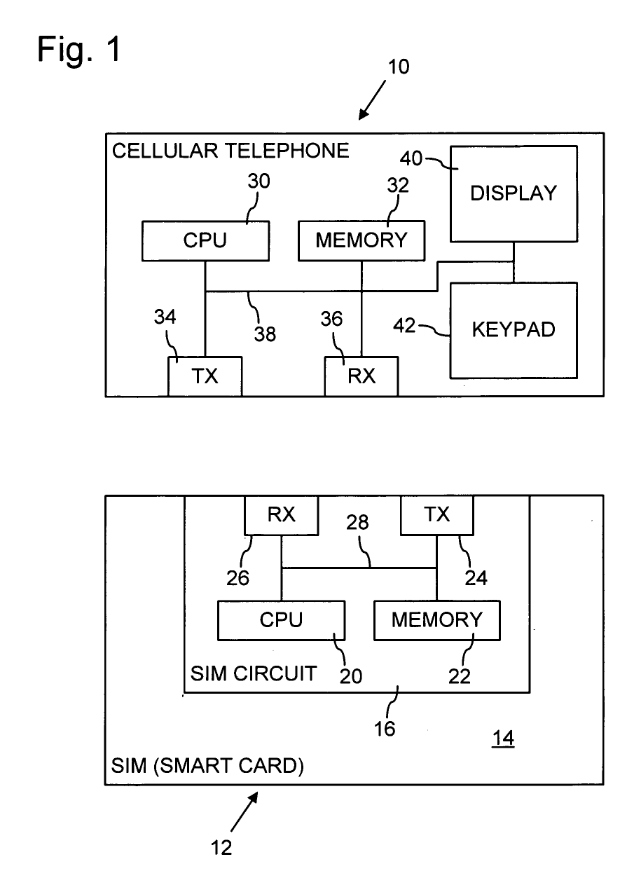

FIG. 1 illustrates a GSM cellular telephone 10 as an exemplary cellular telephone operating environment for an embodiment of the present invention. GSM cellular telephone 10 may conform, for example, to the European Telecommunications Standards Institute (ETSI) specifications GSM 11.11 and GSM 11.14 for Global Systems for Mobile communications. It will be appreciated, however, that GSM cellular telephone 10 could instead conform to another cellular telephone standard or a standard not yet developed, such as the ETSI 3rd Generation Mobile System standard that is sometimes referred to as the Third Generation Partnership Project or “3GPP”.

GSM cellular telephone 10 includes a removable Subscriber Identity Module (SIM) 12, which is sometimes called a smart card or chip card. For example, SIM 12 can be of a smart card format that has the well-known size of credit cards (e.g., standardized dimensions of 53.98 mm×85.60 mm×0.76 mm), or can be of a smaller format that is sometimes called a “plug-in SIM”. SIM 12 includes a medium 14 that supports a SIM electronic circuit 16 (e.g., one or more semiconductor integrated circuits or chips). Medium 14 typically includes multiple laminated synthetic layers, with one or more internal layers being between outer layers. SIM electronic circuit 16 is incorporated into or on at least one of the internal layers.

SIM electronic circuit 16 includes a central processing unit or CPU 20 (e.g., a microprocessor or microcontroller) in conjunction with a memory system 22, a data transmit interface 24, and a data receive interface 26, all of which are interconnected by a bus structure 28. Similarly, GSM cellular telephone 10 includes a central processing unit or CPU 30 (e.g., a microprocessor or microcontroller) in conjunction with a memory system 32, a data transmit interface 34, and a data receive interface 36, all of which are interconnected by a bus structure 38. In addition, GSM cellular telephone 10 includes a system display 40 and a user input device or keypad 42, as well as a power supply (e.g., a battery), telephonic audio input and output elements, and radio frequency transmitting and receiving elements that are not shown.

While SIM electronic circuit 16 includes the basic elements of a simple computer, neither SIM 12 nor SIM electronic circuit 16 is capable of functioning as a stand-alone computer. Neither SIM 12 nor SIM electronic circuit 16 includes a power source or user interface components by which a user could interact with SIM 12 or SIM electronic circuit 16. The computer functionality of SIM 12 can be accessed only by connecting it to another computer, such as GSM cellular telephone 10 or a SIM reader that is connected to a personal computer, as is known in the art. When connected to another computer, such as GSM cellular telephone 10, SIM 12 is powered and communicates through its interfaces 24 and 26 to receive data from and provide data to the other computer.

As is common, GSM cellular telephone 10 supports a fixed length text message service by which radiated (i.e., wireless) fixed length text messages of up to a maximum fixed length may be transmitted or received by GSM cellular telephone 10. As an example, the fixed length text message service could include or conform to the short message service (SMS) standard that is part of the GSM Phase 1 standard. The SMS standard allows transmission of radiated fixed length text messages of up to about 160 characters in length. Such a fixed length text message service conforms to memory constraints and arrangements in GSM cellular telephone 10 and so may be distinguished from conventional network connections or services in which files of generally arbitrary size may be transmitted.

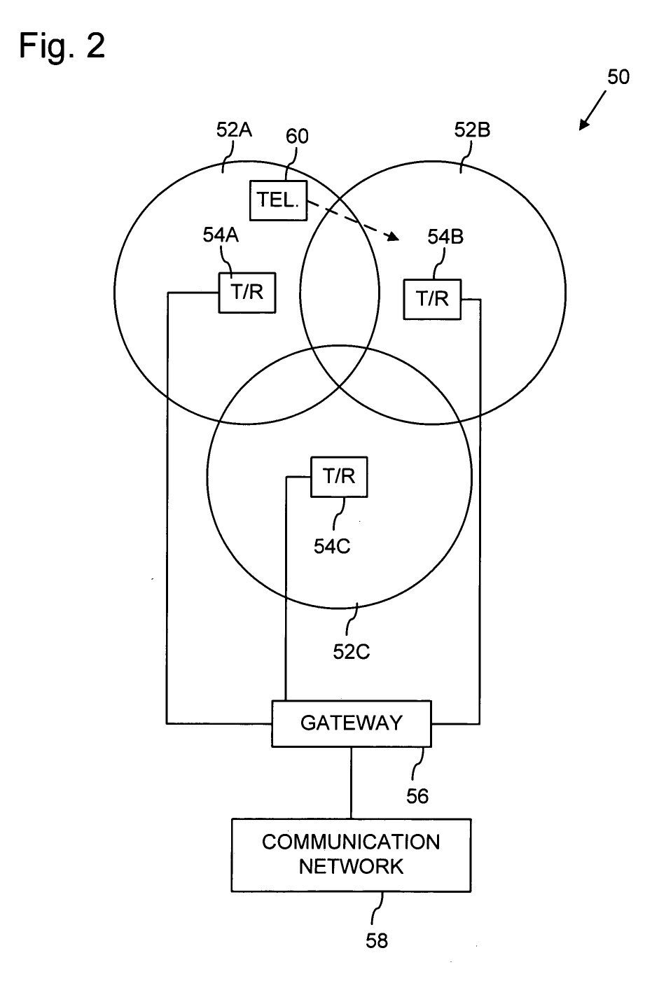

FIG. 2 is a schematic diagram of a conventional cellular telephone system 50 having multiple communication cells 52A, 52B, 52C, etc. Each of communication cells 52A, 52B, and 52C corresponds to at least one wireless or radiating transceiver station 54A, 54B, and 54C, respectively. Transceiver stations 54A, 54B, and 54C communicate with one or more communication gateways 56 (only one shown), which are in communication with a communication network 58 such as a public switched telephone network.

A mobile or wireless cellular telephone 60, which is an exemplary one of typically many cellular telephones (not shown), can be moved among communication cells 52A, 52B, and 52C and maintain seamless communication with communication network 58. Cellular telephone 60 may be of the GSM-type, with the characteristics of GSM cellular telephone 10, or may be based upon any other cellular telephone format or standard.

As is known in the art, cellular telephone 60 within a cell (e.g., 52A) communicates with communication network 58 by establishing a wireless or radiating link with the corresponding transceiver station (e.g., 54A). The communication between cellular telephone 60 and communication network 58 is maintained as cellular telephone 60 passes between cells (e.g., cell 54A to cell 54B) when the link from cellular telephone 60 is passed between the corresponding transceiver stations (e.g., station 54A to station 54B). For example, the link from cellular telephone 60 may be passed between transceiver stations (e.g., station 54A to station 54B) when cellular telephone detects that the radiated signal power from one transceiver station (e.g., station 54B) exceeds the radiated signal power from another transceiver station (e.g., station 54A).

The transceiver station 54 with which cellular telephone 60 is linked at any time is identified within cellular telephone 60 by a cell identification data string. Since cells 52 typically cover overlapping areas to maintain seamless communication as it is moved between them, cellular telephone 60 utilizes the cell identification data string to specify the station 54 with which cellular telephone 60 is linked. Cellular telephone 60 may simultaneously be within range of multiple cells 52 and may have stored in it a cell identification data string for each cell.

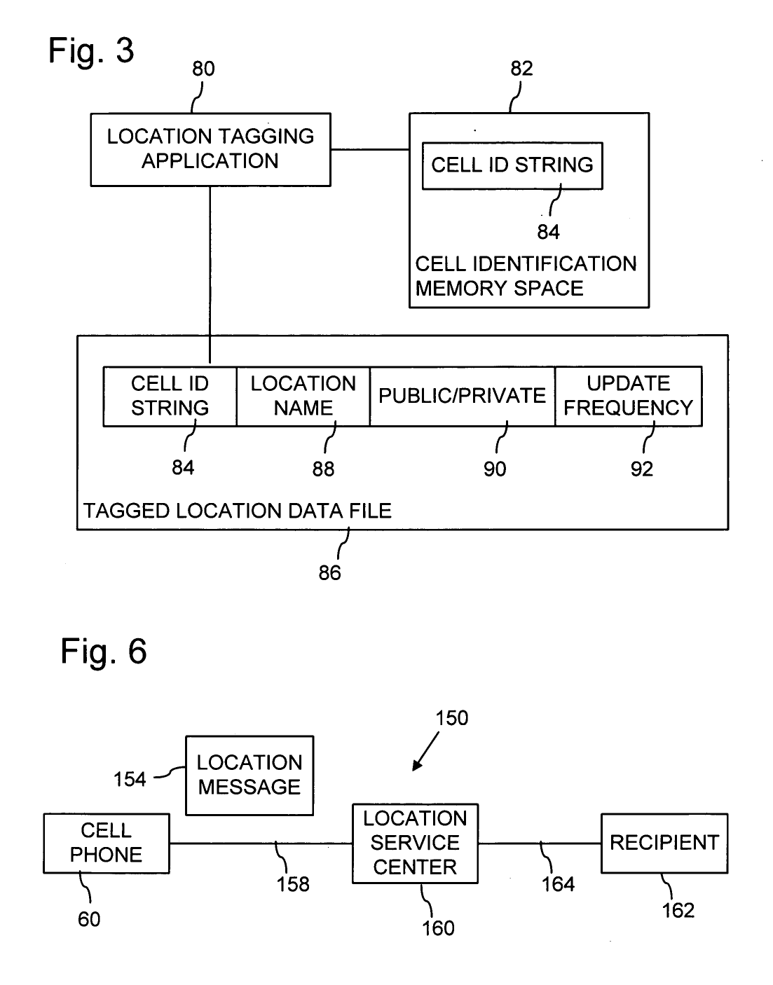

FIG. 3 is a block diagram illustrating operation of a user-controlled cellular telephone location tagging application 80 stored in a memory of cellular telephone 60. As described above, the memory of cellular telephone 60 also includes in a cell identification memory space 82 a cell identification string 84 corresponding to each of the one or more cells 52 (only one shown) with which cellular telephone 60 is in communication. As is known in the art, cell identification string 84 is utilized by cellular telephone 60 to identify a particular one of cells 52 through which communications are to be transmitted.

In one implementation, location tagging application 80 allows or prompts a user to tag a current location of cellular telephone 60, such as by making a predefined entry on the cellular telephone keypad (e.g., keypad 42) or selection of an interface option rendered on the cellular telephone display (e.g., display 40). Upon tagging of a current location, location tagging application 80 copies the at least one cell identification string 84 in cell identification memory space 82 to a tagged location data file 86.

Location tagging application 80 also allows or prompts the user to enter a location name 88 for the current location, such as by entering the name with the cellular telephone keypad (e.g., keypad 42). For example, location name 88 could be “home,” “work,” “friend's house,” etc. Location name 88 is associated with the corresponding cell identification string 84 in tagged location data file 86. Together, location name 88 and cell identification string 84 form in location data file 86 a data structure for user-controlled cellular telephone location data. For example, location data file 86 could be implemented as a look-up table that correlates a cell identification string 84 with a location name 88. It will be appreciated that location data file 86 would typically include user-controlled cellular telephone location data for multiple locations.

An aspect of location tagging application 80 is that it maintains user privacy by maintaining location data on a user's cellular telephone. Conventionally, cellular telephone system operators have been able to identify a cell 52 within which a cellular telephone 60 is located. Such information has sometimes been used in law enforcement situations, but as a generally available resource would be viewed by many users as an invasion of privacy. With location data maintained on a user's cellular telephone, the user can selectively make the location information available to others.

For example, location tagging application 80 may allow or prompt the user to enter a public/private indication 90 that establishes whether location data on the user's cellular telephone is to be made available to others, such as by transmitting the location data from the cellular telephone to cellular telephone system 50. The location data (e.g., location name 88 only) would be transmitted only if a public state were indicated. In one implementation, the location data may be transmitted to cellular telephone system 50 in a standard text message format, such as a SMS message format.

If public/private state indication 90 is public to indicate that the location data is to be made available to others, location tagging application 80 may also allow or prompt the user to enter a frequency indication 92 to establish a frequency at which the location data on the user's cellular telephone is to be made available to others. In one implementation, the location information is made available to others according to a list (e.g., other cell phones or computers) that is created by the user and identifies who (i.e., what device) is to receive updated location data.

The location data would be transmitted at a frequency that could be indicated as a time period between each transmission or “update” (e.g., 60, 30, 15 minutes). For example, one time period could be a default frequency that is used by location tagging application 80 in the absence of another frequency specified by the user. In one implementation, a location information update is triggered when the cellular telephone is switched on and upon a change of the main cell that the cellular telephone is using. The cellular telephone sends the update to registered or identified “users” (e.g., other cellular telephones or computers) by sending SMS messages to each one. In an implementation that reduces messaging costs, the cellular telephone sends the location update to one server that in turn broadcasts the information to the same registered “users.”

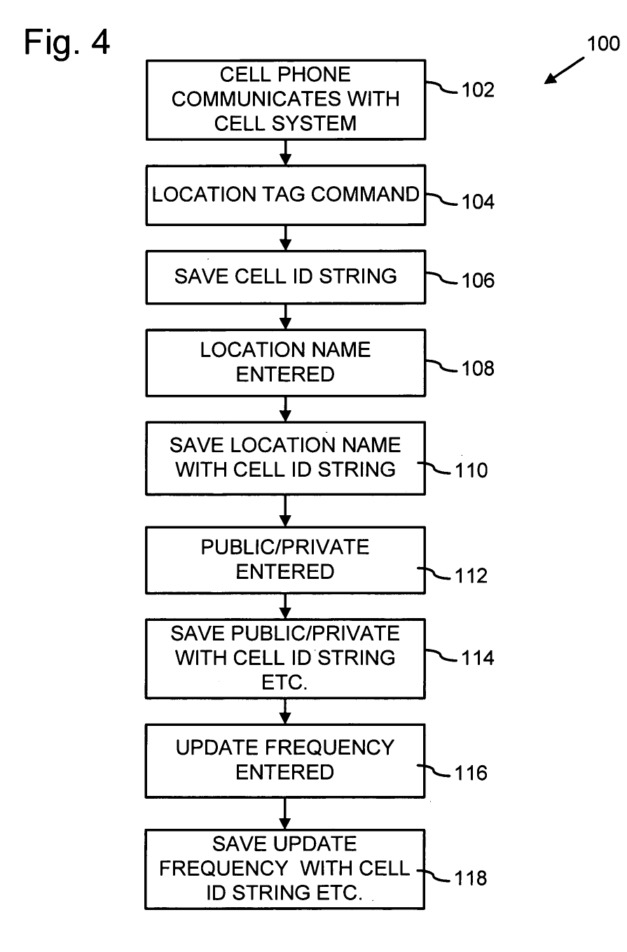

In accordance with the present invention, FIG. 4 is a flow diagram of a user-controlled cellular telephone location tagging method 100 by which a cellular telephone user may register a cellular telephone location on a cellular telephone, the location corresponding to the position of a cellular telephone 60 in a region encompassed by one or more cells 52 of a cellular telephone system 50. User-controlled cellular telephone location tagging method 100 may be executed by a location tagging application (i.e., software instructions) stored on the cellular telephone 60. In an implementation in which cellular telephone 60 is a GSM cellular telephone 10, the location tagging application may be stored on GSM cellular telephone 10 or SIM electronic circuit 16 of SIM 12.

Process block 102 indicates that a cellular telephone is in communication with at least one cell of a cellular telephone system.

Process block 104 indicates that a user enters a location tag command on the cellular telephone. For example, with a location tagging application running on the cellular telephone, the user may actuate a selection of a location tag command with reference to a command prompt displayed on the cellular telephone.

Process block 106 indicates that a cell identification string of a cell with which the cellular telephone is communicating is saved on the cellular telephone as a tagged location cell identification string.

Process block 108 indicates that the user enters a location name on the cellular telephone, such as in response to a prompt from the cellular telephone.

Process block 110 indicates that the location name is saved in association with the tagged location cell identification string. For example, the location name and tagged location cell identification string may be stored in a look-up table that correlates location names with corresponding tagged location cell identification strings.

Process block 112 indicates that the user enters on the cellular telephone a public/private indication of whether the location is to be made publicly available to others. This entry can be made in response to a prompt from the cellular telephone.

Process block 114 indicates that the public/private indication is saved in association with the tagged location cell identification string and the location name.

If the location is indicated to be publicly available, process block 116 indicates that the user enters a location update frequency representing the frequency at which the location, or all publicly available locations, are to be made available to others. This entry can be made in response to a prompt from the cellular telephone.

Process block 118 indicates that the location update frequency is saved in association with the other location data.

Typically, each cell 52 in a cellular telephone system 50 will encompass an area of several square miles. If only one cell identification string of only one cell 52 is associated with each location name, a user could unambiguously identify only one location for each cell 52. While such a coarse location resolution could be suitable for many users, some users might wish to specify more than one location within the region encompassed by a particular cell 52.

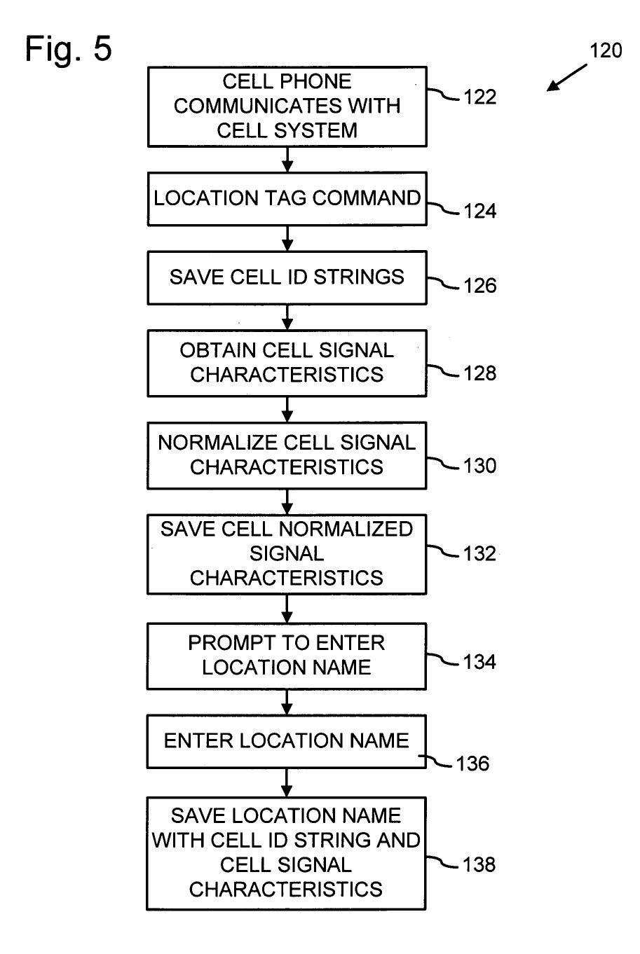

FIG. 5 is a flow diagram of another implementation of a user-controlled cellular telephone location tagging method 120 by which a cellular telephone user may register a cellular telephone location on a cellular telephone.

Process block 122 indicates that a cellular telephone is in communication with at least one cell of a cellular telephone system.

Process block 124 indicates that a user enters a location tag command on the cellular telephone.

Process block 126 indicates that each cell identification string for each cell with which the cellular telephone is communicating is saved on the cellular telephone as one or more tagged location cell identification strings.

Process block 128 indicates that a cell signal characteristic (e.g., power) indication for each cell with which the cellular telephone is communicating is obtained on the cellular telephone for each of the tagged location cell identification strings. Cell signal power indications could correspond to the radiated signal transmission power for each cell as determined by the cellular telephone.

Process block 130 indicates that the cell signal power indications are normalized with respect to a normalization factor to form normalized cell signal power indications. The multiple cell signal power indications provide multiple power indications that can identify many locations with a much higher resolution than can a single cell. Normalization of the power indications is an optional step which maintains the improved location correlation even when transmission power received by the cellular telephone varies for all cells, such as when the cellular telephone is in or out of a building or automobile.

Process block 132 indicates that the normalized cell signal power indications are saved on the cellular telephone as a tagged location cell identification string.

Process block 134 indicates that the user is prompted to enter a location name on the cellular telephone.

Process block 136 indicates that that the user enters the location name.

Process block 138 indicates that the location name is saved in association with the tagged location cell identification string and the cell signal characteristics.

FIG. 6 is a block diagram illustrating operation of a user-controlled cellular telephone location posting system 150 for posting or otherwise providing location information regarding a cellular telephone 60 in a cellular telephone system 50. For purposes of simplicity, this illustration is directed to providing location information in only direction: from cellular telephone 60 to location posting system 150. It will be appreciated that cellular telephone 60 and location posting system 150 could be capable of bi-directional communication so that the following description would be similarly applicable to communication from location posting system 150 to cellular telephone 60.

A user-specific location message 154 created at cellular telephone 60 is transmitted over a communication channel 158 to a cellular telephone location service center 160 that functions as a store and forward center for transmitting location information. In one implementation, cellular telephone location service center 160 may be associated with or included in a short message service center that processes SMS-format text messages available with many GSM cellular telephones, or may be transmitted over another communication channel or in another communication format.

For example, location service center 160 receives an encrypted text location message 154 from cellular telephone 60 and stores location message 154 until it is to be forwarded to a recipient 162. Location message 154 includes a cellular telephone user identity (e.g., a cellular telephone number, sometimes referred to herein as a telephonic address) and a location indicator (e.g., a location name). The cellular telephone user identity may be associated at location service center 160 with other registered identities of the user (e.g., instant messaging identities, network user identities, etc.). Recipient 162 may be or include any telephonic, cellular telephonic, or computer network (e.g., Internet) based user or service, including instant messaging services (MSN, Yahoo, AOL, etc.) or users, email services or users, cellular telephone users, etc., or any other computer-based program that can register the state string sent by the phone, correlate the information with a user identity, store it and display it on the web or within any computer application to be queried. In the context of an instant messaging system, for example, the location information can appear in addition to the status information currently used (e.g., typing, away, busy, logged off).

Location service center 160 transmits location information from location message 154 to recipient 162 over a communication channel 164. Location service center 160 may transmit the location information in response to a query from a recipient 162 or may automatically broadcast the location information to specified recipients 162. Location service center 160 can actively send status and location status updates to specified services in specified formats and therefore publish the information regarding the cellular user status and location status. Communication channels 158 and 164 may be or include any public or private computer network (e.g., the global computer network called the Internet) or any telephone network (e.g., any PSTN or any cellular or other wireless communication network).

In the descriptions above, location information is obtained and managed by a cellular telephone user independently of a cellular telephone system operator. It will be appreciated, however, that in other implementations the cell identification data string or strings included in the location information could be transmitted from a user cellular telephone to a cellular telephone system operator as part of a location information service.

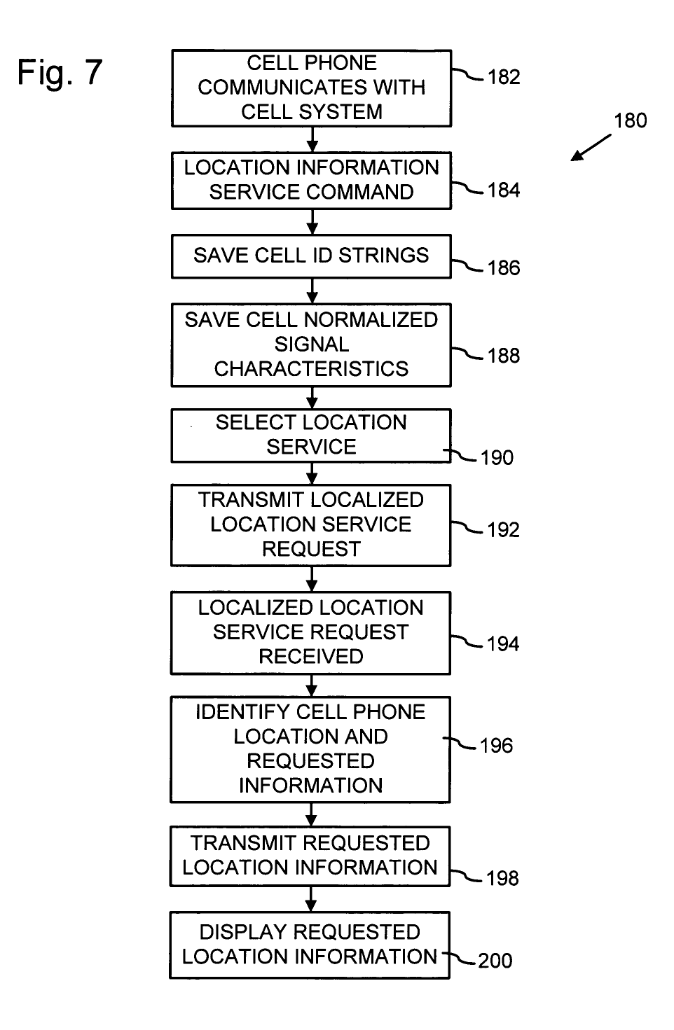

FIG. 7 is a flow diagram of a cellular telephone location information method 180 by which a cellular telephone system operator can provide a location information service to a cellular telephone user.

Process block 182 indicates that a cellular telephone is in communication with at least one cell of a cellular telephone system.

Process block 184 indicates that a user enters a location information service command on the cellular telephone.

Process block 186 indicates that each cell identification string for each cell with which the cellular telephone is communicating is saved on the cellular telephone as one or more tagged location cell identification strings.

Process block 188 indicates that normalized cell signal power indications are saved on the cellular telephone with the tagged location cell identification strings.

Process block 190 indicates that the user indicates on the cellular telephone a location service command for selecting a location service, such as from the cellular telephone system operator or another service provider. For example, an “I am lost” service command could function as a request for a description or name of a current location of the cellular telephone. An “I need instructions to get to my destination” service could function as a request for directions from a current location of the cellular telephone to a destination location entered by the user. An “Assisted tagging” service could assist a user with tagging or naming a location being tagged by the user by providing a suggested name or description, thereby freeing the user from manually entering it.

Process block 192 indicates that the normalized cell signal power indications, together with an indication of the location service being requested, are transmitted as a localized location service request from the cellular telephone to the cellular telephone system operator or another service provider.

Process block 194 indicates that the localized location service request is received by the cellular telephone system operator or another service provider.

Process block 196 indicates that the location of the cellular telephone user is identified from the normalized cell signal power indications and the information corresponding to that cellular telephone location and the requested location service is determined. For example, in an “I am lost” service request, the location service information could be a description or name of a current location of the cellular telephone (e.g., street intersection). In an “I need instructions to get to my destination” service request, the location service information could be text directions from a current location of the cellular telephone to the destination location entered by the user. In an “Assisted tagging” service, the location service information could be a suggested name or description of the current location, thereby freeing the user from manually entering it.

Process block 198 indicates that the requested location service information is transmitted to the cellular telephone.

Process block 200 indicates that the requested location service information is displayed on the cellular telephone.

Location information method 180 is described with reference to an implementation in which information is provided back to a cellular telephone user. It will be appreciated that in other implementations, the information service could provide the information to a recipient other than the cellular telephone user.

For example, the cellular telephone system operator or another service provider could periodically translate the cellular telephone location information into a location name or description that could be forwarded to a different recipient, such as a dispatcher for the cellular telephone user. As one example, a delivery vehicle could be tracked by a delivery dispatcher. Such a system could be an inexpensive substitute for a satellite-based tracking system, as is used by some delivery companies.

As another example, the cellular telephone system operator or another service provider could translate the cellular telephone location information into a location name or description that could be forwarded to a different recipient only upon a singular event, such as a request for a particular service (e.g., a taxi service). Such a system could allow a taxi dispatcher to send the nearest available taxi based on location status. The same feature could be applied to a call to an emergency (e.g., 911) service.

In accordance with the practices of persons skilled in the art of computer programming, the present invention is described above with reference to acts and symbolic representations of operations that are performed by various computer systems, including mobile communication devices and “smart cards.” Such acts and operations are sometimes referred to as being computer-executed and may be associated with the operating system or the application program as appropriate. It will be appreciated that the acts and symbolically represented operations include the manipulation by a CPU of electrical signals representing data bits, which causes a resulting transformation or reduction of the electrical signal representation, and the maintenance of data bits at memory locations in a memory system to thereby reconfigure or otherwise alter the computer system operation, as well as other processing of signals. The memory locations where data bits are maintained are physical locations that have particular electrical, magnetic, or optical properties corresponding to the data bits.

Having described and illustrated the principles of our invention with reference to an illustrated embodiment, it will be recognized that the illustrated embodiment can be modified in arrangement and detail without departing from such principles. It should be understood that the programs, processes, or methods described herein are not related or limited to any particular type of computer apparatus, unless indicated otherwise. Various types of general purpose or specialized computer apparatus may be used with or perform operations in accordance with the teachings described herein. Elements of the illustrated embodiment shown in software may be implemented in hardware and vice versa.

In view of the many possible embodiments to which the principles of our invention may be applied, it should be recognized that the detailed embodiments are illustrative only and should not be taken as limiting the scope of our invention. Rather, we claim as our invention all such embodiments as may come within the scope and spirit of the following claims and equivalents thereto.

1. In a computer readable medium of a cellular telephone, a cellular telephone location tagging application, comprising:
instructions for obtaining location information data corresponding to a location of the cellular telephone in a cellular telephone system; and
instructions for associating on the cellular telephone a location name and the location information data.

2. The medium of claim 1 further comprising instructions for transmitting the location information data from the cellular telephone selectively according to a user-specified location status indication.

3. The medium of claim 2 further comprising instructions for separately establishing a user-specified location status indication with the location information for each selected location.

4. The medium of claim 1 further comprising instructions for establishing a user-specified recipient of the location information.

5. The medium of claim 4 in which the user-specified recipient is a telephonic or computer network address associated with a particular user.

6. The medium of claim 4 in which the user-specified recipient is a computer network service or telephonic service.

7. The medium of claim 1 in which the location information data includes plural cell identification strings corresponding to plural cells of a cellular telephone system with which the cellular telephone is in communication and in which the plural cell identification strings are associated with the location name.

8. The medium of claim 7 further comprising:
instructions for obtaining on the cellular telephone a cell signal characteristic that characterizes a cellular transmission signal for each of the plural cells with which the cellular telephone is in communication; and
instructions for associating on the cellular telephone the cell signal characteristic with the location name and each corresponding cell identification string.

9. The medium of claim 8 in which the cell signal characteristic includes signal strength.

10. The medium of claim 1 further comprising instructions for establishing a computer network instant messaging service as a recipient of the location information.

11. A cellular telephone location posting system, comprising:
a cellular telephone location tagging application adapted to be stored and operated on a cellular telephone, the application obtaining designed to obtain a cell identification string corresponding to a cell of a cellular telephone system with which cell the cellular telephone is in communication and associating adapted to associate on the cellular telephone a location name and the cell identification string as location information for a selected location; and
a cellular telephone location service center that is designed to receive the location information from the cellular telephone and selectively forward the location information to a predefined recipient.

12. The system of claim 11 in which the location information is selectively forwarded according to a location status indication included with the location information from the cellular telephone.

13. The system of claim 11 in which the cellular telephone has an associated user who has one or more computer network identities and in which the cellular telephone location service center associates the location information with the one or more computer network identities of the user.

14. The system of claim 11, in which the cellular telephone location tagging application is designed to obtain the predefined recipient from the user of the cellular telephone.

15. The system of claim 14 in which the location information is selectively forwarded to the predefined recipient at a computer network address.

16. The system of claim 14 in which the location information is selectively forwarded to the predefined recipient at a telephonic address.

17. A method, comprising:
obtaining location information data corresponding to a location of the cellular telephone in a cellular telephone system; and
associating on the cellular telephone a location name and the location information data.

18. The method as in claim 17, further comprising obtaining on the cellular telephone a cell signal characteristic that characterizes a cellular transmission signal for each of the plural cells with which the cellular telephone is in communication; and
associating on the cellular telephone the cell signal characteristic with the location name and each corresponding cell identification string.

19. The method as in claim 17, further comprising associating a user-specified public/private indication with the location name.

20. The method as in claim 17, further comprising transmitting the location information based on the public/private indication.
